(19) United States
(12) Patent Application Publication
(10) Pub. No.: US 2008/0181606 A1
(43) Pub. Date: Jul. 31, 2008

(54) Optical bi-directional line-switched ring transmission system, transmission apparatus, and through cross-connect setting method

(75) Inventor: Naokatsu Ohkawa, Kawasaki (JP)

Correspondence Address: HANIFY & KING PROFESSIONAL CORPORATION, 1875 K STREET, NW, SUITE 707, WASHINGTON, DC, 20006, US

(73) Assignee: FUJITSU LIMITED

(21) Appl. No.: 12/010,360

(22) Filed: Jan. 24, 2008

(30) Foreign Application Priority Data
Jan. 26, 2007 (JP) 2007-015774

(51) Int. Cl. H04J 14/00

(52) U.S. Cl. 398/50

(57) ABSTRACT

An optical bi-directional line-switched ring transmission system includes a unit configured to transmit, from a transmission source node in a signal path for setting a cross-connect to an adjacent node, squelch information storing identity information of a transmission source node and a transmission destination node in a squelch information region provided in an optical overhead, in an own node that has received the squelch information, a unit configured to allocate cross-connect setting information based on the transmission source and transmission destination identity information, judge whether an own node is a transmission destination node or a through node of the cross-connect, execute through cross-connect setting in the own node; and—a notifying unit configured to, when the own node has been judged to be the transmission destination node of the cross-connect, notify a user with a message indicating that a cross-connect setting request exists.

### 1. BACKGROUND

The present invention relates to an optical bi-directional line switched ring (BLSR) transmission system, a transmission apparatus, and a through cross-connect setting method for automatically setting a cross-connect, which is a signal path setting, in each through node on a signal path between a transmission source and transmission destination of a signal.

### 2. DESCRIPTION OF THE RELATED ART

The optical bi-directional switched ring (BLSR) transmission system is described with reference to FIG. 5. FIG. 5 shows an example of construction of an optical bi-directional line switched ring (BLSR) transmission system made up of six stations (nodes). As shown in FIG. 5, the nodes (A through F) are connected in a ring-state using an optical fiber having a transmission speed of 2.5 Gbps (OC48) or 10 Gbps (OC192), and each transmits and receives signals on a bi-directional transmission path.

For example, when setting the signal path from node A to node C, connection settings for the signal path (channel), or “cross-connects”, in the nodes are performed on each of node A, node B, and node C. Generally, the connection setting is performed using STS1 (Synchronous Transport Signal (level)-1) units (1.5 Mbps).

The optical bi-directional switched ring (BLSR) transmission system forms a closed circuit with redundancy by allocating one half of the transmission bandwidth to a work line and the other half to a protection line. In the case of the 2.5 Gbps (OC48) optical bi-directional line-switched (BLSR) transmission system, the available bandwidth includes 48 STS1 channels, with channel numbers 1 through 24 (ch 1 through ch 24) being allocated to the work line and channel numbers 25 through 48 (ch 25 through ch 48) being allocated to the protection line.

As shown in FIG. 5, in the event of a failure occurring in channel (ch 1) of the work line between node A and node B, node A forms a signal path of node A→node F→node E→node D→node C→node B using a protection line channel (ch 25), thereby saving the path from node A to node B.

The following describes setting the cross-connect with reference to FIG. 6. As shown in FIG. 6, in the example of construction of the optical bi-directional line-switched ring (BLSR) transmission system including the six nodes A through F, a channel (ch 1) is set as a signal path from node A to node D, and a channel (ch 4) is set as a signal path from the node B to the node C.

Here, it is assumed that concatenation type (concatenation: linking) for the channel (ch 1), which is the signal path from node A to node D, is of the STS3C type (a group of three STS1) and that the concatenation type for the channel (ch 4), which is the signal path from node B to node C, is STS1. In order to set these signal paths, the user has to send a cross-connect setting command to each of the nodes A through D. (An example of such a command is “ENT-CRS . . . ”)

The cross-connect setting command is sent using an “ENT - CRS - STSx:: From AID, To AID” command system. Here, STSx represents the concatenation type, and AID is access identity information, expressed in the form “slot number - port number - channel number” of an input side point of the signal path in the transmission source node or an output side point of the signal path in the transmission destination node.

To the node A, the user sends the concatenation type STS3 of the channel (ch 1) and the cross-connect setting command “ENT - CRS - STS3C: : x - x - x, 6 -1- 1;” including the access identity information x - x - x of a signal add point in the own node, and the access identity information 6 - 1 - 1 of the output-side point.

To the node B, the user sends the concatenation type STS3 of the channel (ch 1) and the cross-connect setting command “ENT - CRS - STS3C: : 7 - 1 - 1, 8 -1 -1;” including the access identity information 7 - 1 - 1 of the input-side point and the access identity information 8 - 1 - 1 of the output-side point.

To the node C, the user sends the concatenation type STS3 of the channel (ch 1), and the cross-connect setting command “ENT - CRS - STS3C: : 5 - 2 - 1, 6 - 2 - 1;” including the access identity information 5 - 2 - 1 of the input-side point and access identity information 6 - 2 - 1 of the output-side point.

To the node D, the user sends the concatenation type STS3 of the channel (ch 1) and the cross-connect setting command “ENT - CRS - STS3C: : 2- 1 - 1, x - x - x;” including the access identity information 2 - 1 - 1 of the input-side point and the access identity information x - x - x of a signal drop point in the own node.

To the node B, the user further sends the concatenation type STS1 of the channel (ch 4) and the cross-connect setting command “ENT - CRS - STS1: : x - x - x, 8 -1 - 4;” including the access identity information x - x - x of the signal add point in the own node and the access identity information 8 - 1 - 4 of the output-side point.

To the node C, the user further sends the concatenation type STS1 of the channel (ch 4) and the cross-connect setting command “ENT - CRS - STS1: : 5 - 2 - 4, x - x - x;” including the access identity information 5 - 2 - 4 of the input-side point and the access identity information x - x - x of a signal drop point in the own node.

The following describes a construction of a squelch table. After completing the cross-connect setting, a squelch table (table of attainable nodes) has to be constructed. The reason for this is as follows. In the event of failures occurring in the transmission line between node A and node B and in the transmission line between node C and node D as shown in FIG. 7, the signal path from the node A to the node D can be saved using a detour path which passes through node F and node E. However, since an attainable detour path cannot be formed for the signal path from node B to node C, the signal path from node B to node C cannot be saved.

As shown in the example of FIG. 7, when failures have occurred in the transmission lines on both sides of node B, no signal from node B will reach any other node. However, if a failure occurs between two or more separated nodes, the nodes detecting the transmission failure may each begin operations to form a detour path using a protection line, thereby setting a detour path with a same channel number on the protection line between unanticipated nodes. In such a case, an erroneously connected signal path between nodes that were not originally connected will be formed.

To prevent signal communication via this type of erroneous connection, it is necessary to determine transmission paths that cannot be saved using a detour based on a pre-formed squelch table (table of attainable nodes) and information about a location of the occurrence of the transmission line failure, and implement squelch processing by converting signals outputted on the signal path to logic value signals, which are “1” or the like.

Hence, for each node, it is necessary to create and store a squelch table showing “node to node signal paths as connection settings” for each channel. The squelch tables are constructed automatically by communicating between nodes squelch information including a transmission source node ID and a transmission source node ID for each channel using a D5 byte and D6 byte of an optical overhead, and having each node execute a sequence of operations based on the squelch information.

FIG. 8 shows a format of the D5 byte and the D6 bytes of the optical overhead. As shown in FIG. 8, a D5#3 byte is transmitted with a node ID (source ID) of the transmission source node (add node), a node ID (destination ID) of a transmission destination node (drop node) and a channel number stored therein.

In the example of construction shown in FIG. 7, node A is the signal transmission source node (add node). Hence, squelch information (1) including the channel number “1” and the own node ID “01” as the transmission source node ID is set in the optical overhead and transmitted. On receipt of the squelch information (1), the node B and the node C forward the squelch information (1) in an unaltered form to the succeeding nodes because the cross-connect settings do not list the respective own nodes as the transmission destination corresponding to channel number “1”.

The above-described squelch information is forwarded to node D and received by node D as squelch information (2). Since node D is the transmission destination of the channel corresponding to channel number “1” in the cross-connect settings, it responds with squelch information (3) for which the node D has set an own node ID “04” as the transmission destination ID to indicate that node D is the transmission destination node (drop node). The squelch information (3) also includes the channel number “1” and the transmission source node ID “01”

As well as returning the above-described response, the node D constructs a squelch table 7-4 by storing the transmission source node ID (SRC) and the transmission destination node ID (DST) of the channel ch 1 in a squelch table format. On receipt of the squelch information (3) transmitted as a response from the above-described node D, the node A recognizes a signal path from the node corresponding to the node ID “01” to the node corresponding to the node ID “04”, and constructs a squelch table 7-1. The node C and the node B recognize that the transmission source node ID (SRC) is “01” and the transmission destination ID (DST) is “04” for the channel ch1 based on the data of the passing squelch information (3), and store these values in squelch table format, thereby constructing squelch tables 7-2 and 7-3 respectively.

In the example of FIG. 7, the concatenation type STS3C (group of 3 STS1) signal paths from node A to node D are cross-connected using the channels ch 1 through ch 3. As shown in FIG. 7, for the channels ch 2 and ch 3, the nodes A through D each store “01” as the transmission source node ID (SRC) and “04” as the transmission destination ID (DST) in the corresponding squelch tables 7-1 through 7-4 in the same way as for the channel ch 1.

Similarly, when the concatenation type STS1C (a single STS) connection path from node B to node C is cross-connected using channel 4, the node B and the node C store, in the squelch tables 7-2 and 7-3 respectively, a node ID “02” of the node B as the transmission source node ID (SRC) and a node ID “03” of the node C as the transmission destination node ID (DST).

In this way, a squelch table is automatically constructed in each node based on the node ID (source ID) of the transmission source node (add node), the node ID (destination ID) of the transmission destination node (drop ID), and the channel number as the squelch information in the optical overhead. However, a command is provided to allow direct editing of the squelch tables by a manual operation to allow for circumstances in which for some reason the squelch tables cannot be constructed automatically.

In terms of prior art relating to the present invention, Japanese Patent Application Laid-Open No. 2000-358052 discloses a ring network transmission system which is capable of setting or dissolving cross-connects for nodes in the ring network by a single execution per unidirectional path of a request from a network management apparatus at a time of setting or releasing the cross-connects. Further, in the ring network transmission system, cross-connect setting is executed automatically without executing cross-connect setting requests from a network management apparatus when increasing the number of nodes in the ring network or recovering from node faults.

When setting the cross-connects, all the user wishes to do is to set “channel ch 1 to have signals added at node A (ID=“01”) and dropped at node D (ID=“04”)” as shown in the example of FIG. 6. However, in reality, the user has to perform cross-connect setting for the through nodes, node B and node C.

In the case of the 10 Gbps (OC192) optical bi-directional line-switched ring (BLSR) transmission system, it is possible to set cross connects for 192 STS1 channels. However, to implement cross-connect setting including the through node setting for 192 channels, a large amount of manual work is required. Moreover, it is easy for setting errors to occur due to mistaken operations. Therefore, if the setting of cross-connects for the through nodes can be performed automatically, the procedure for cross-connect setting will be greatly improved.

### 3. SUMMARY

The present invention provides an optical bi-directional line-switched ring transmission system and a through cross-connect setting method capable of automatic cross-connect setting for through nodes using only software or firmware and not requiring hardware alterations.

An optical bi-directional line-switched ring transmission system having a plurality of nodes connected in a ring-state, comprises a unit configured to transmit, from a transmission source node in a signal path for setting a cross-connect to an adjacent node, squelch information storing identity information of a transmission source node and a transmission destination node in a squelch information region provided in an optical overhead as an information region for construction of a squelch table, in an own node that has received the squelch information, a unit configured to allocate cross-connect setting information based on the transmission source and transmission destination identity information and a concatenation type judged from setting information of the optical overhead, judge whether an own node is a transmission destination node or a through node of the cross-connect, and when judging that the own node is the through node, execute through cross-connect setting in the own node; and a notifying unit configured to, when the own node has been judged to be the transmission destination node of the cross-connect, notify a user with a message indicating that a cross-connect setting request exists.

### 4BRIEF DESCRIPTION OF THE DRAWINGS

FIG. 1 is a diagram illustrating cross-connect settings of a transmission source node in the present invention;

FIG. 2 is a diagram illustrating through cross-connect settings of a through node in the present invention;

FIG. 3 is a diagram illustrating a cross-connect settings of a transmission destination node in the present invention;

FIG. 4 is diagram showing a flow of processing of the cross-connect setting and squelch table construction of the present invention;

FIG. 5 is diagram showing an example of construction of an optical bi-directional line-switched ring (BLSR) transmission system;

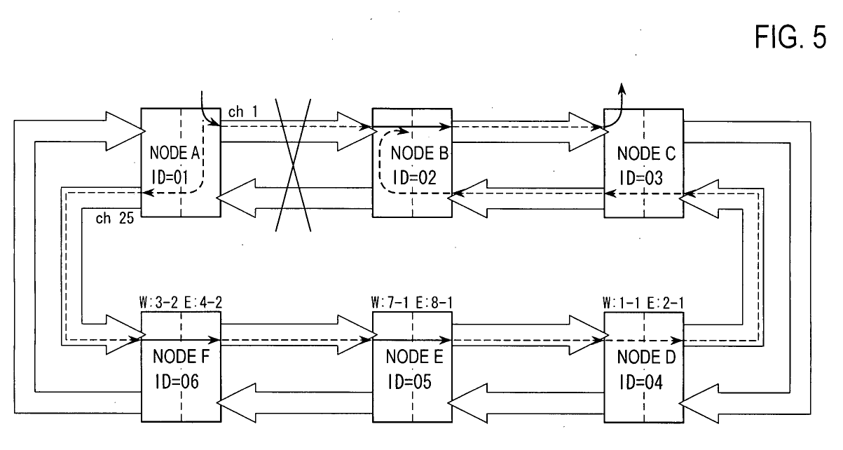

FIG. 6 is a diagram illustrating cross-connect setting;

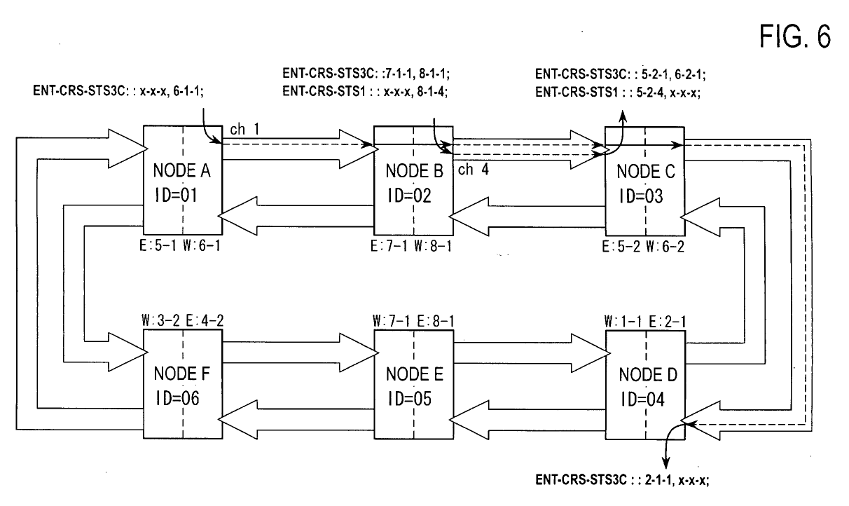

FIG. 7 is diagram illustrating squelch table construction; and

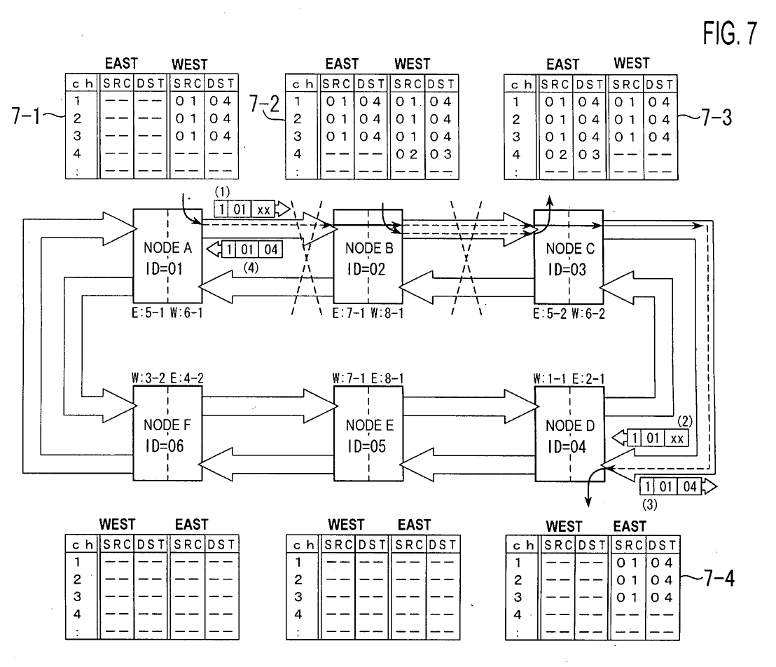

FIG. 8 is a diagram showing a format of a D5 byte and a D6 byte of the optical overhead.

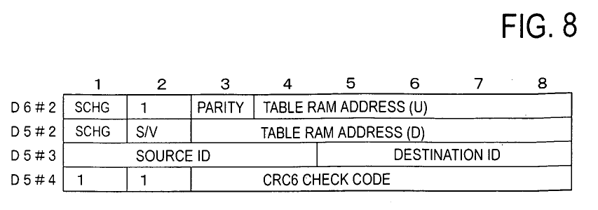

### 5. DETAILED DESCRIPTION OF THE EMBODIMENTS

### Description of the Preferred Embodiments

If information composed of access IDs (slot number - port number - channel number) for a transmission source node and a transmission destination node together with a concatenation type (STS1, STS3C or the like) is specified, it is possible to perform cross-connect setting automatically. The following describes procedures for acquiring the above-described information and automatically setting the cross-connects of through nodes.

(Procedure 1) Setting Cross-Connects for Transmission Source (Add) Nodes (Same as Conventional Procedure)

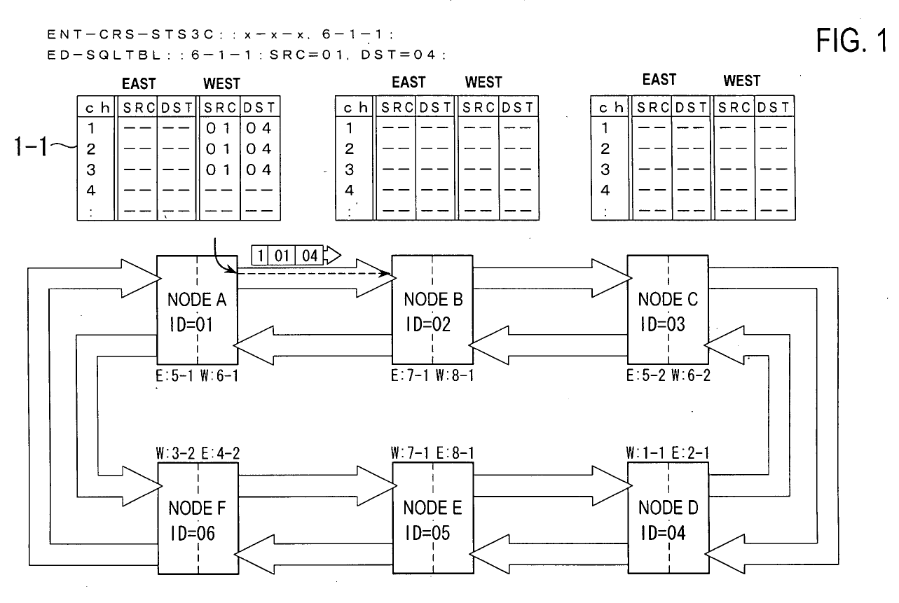

FIG. 1 shows a cross-connect setting (“ENT - CRS - STS3C: : x - x - x, 6 - 1 - 1”) command that is cast to node A (ID=“01”) which is the transmission source (add) node. In this cross-connect setting, although the physical transmission destination is the optical bi-directional line-switched ring (BLSR), the transmission source access ID (x - x - x) cannot be specified by the node A apparatus itself. Hence, a user who is going to make use of the cross-connect performs the settings manually in the conventional way.

(Procedure 2) Setting of Squelch Information

Conventionally, on completion of the cross-connect setting for node A, squelch information “SRC=“01”, DTS=undefined (“xx”)” was transmitted from node A. In the present invention, however, squelch tables are set using a manual command (ED -SQLTBL) for editing and setting the squelch table. Specifically the squelch table 1-1 is set using the command (ED - SQLTBL: : 6 - 1- 1: SRC=01, DST=04) which indicates that “for channel 1, node A (ID=“01”) is the transmission source and node D (ID=“04”) is the transmission destination”. This setting information is then saved in a squelch information region of the optical overhead (a D5 byte and a D6 byte) and transmitted to successive adjacent nodes.

(Procedure 3) Distinguishing Through Cross-Connects (Paths)

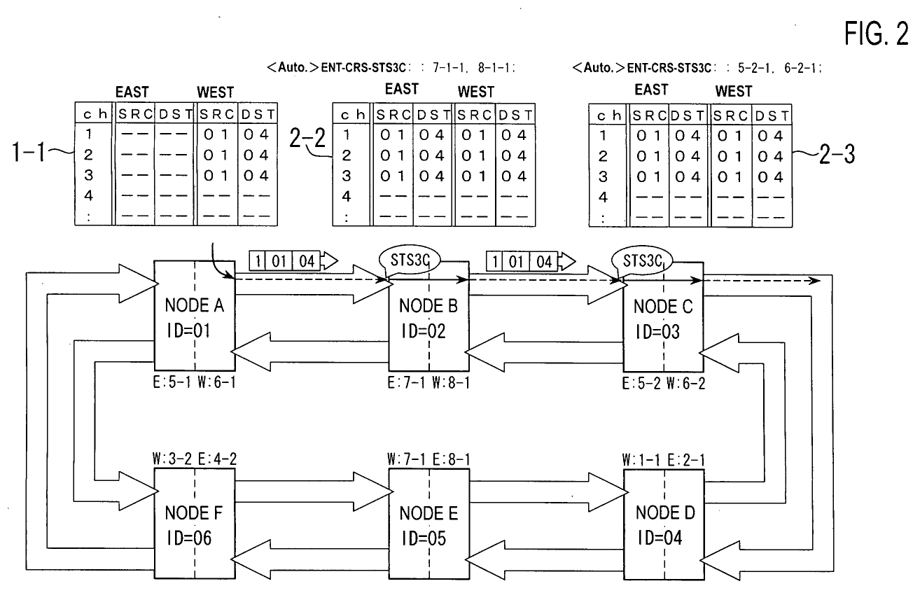

As shown in FIG. 2, on receipt of squelch information indicating that “for channel ch 1, node A (ID=“01”) is the transmission source and node D (ID=“04”) is the transmission destination”, the adjacent node B recognizes that the transmission destination ID (DST) is “04” while an own node ID is “03”, and thereby judges node B (itself) to be a through node.

Based on a channel input point at which the above described squelch information was received (channel number 1 of port number 1 of slot number 7 on the east side), the node B reads optical bi-directional line-switched ring (BLSR) node setting information (in this example, information indicating that signals from an input-side point, east side 7-1, are to be outputted from an output-side point, west side 8-1) and thereby determines a through cross-connect path. In this example, the signal path is 7 - 1 - 1 to 8 - 1 - 1.

(Procedure 4) Distinguishing Concatenation of Through Cross-Connects (Paths)

The node B then determines a concatenation type (STS1, STS3C or the like) of the channel ch 1. In an optical fiber signal input device, the concatenation type can be determined from optical overhead setting information. In other words, the concatenation type of the optical input-side point is determined in accordance with the input-side point of the channel receiving the squelch information (channel number 1 of port number 1 of slot number 7 in this example).

In this case, STS3C signals are flowing from node A, and so node B determines that the concatenation type for channel 1 is STS3C. Using the squelch information of the above-described procedure 3 and the concatenation information of procedure 4, the node B determines that “for channel ch1, a through cross-connect of concatenation type STS3C is to be set”, and automatically executes a command cast “ENT - CRS - STS3C: : 7 - 1 - 1, 8 - 1 - 1;”. The node B also automatically updates the squelch table 2-2. The node C operates in a similar manner, automatically executing a command cast of “ENT - CRS - STS3C: : 5 - 2 - 1, 6 - 2 - 1;” and automatically updating a squelch table 2-3.

By this process and as shown in FIG. 2, the node B and the node C set the squelch tables to have transmission source node IDs (SRC)=“01” and the transmission destination IDs (DST)=“04” for channels ch 1 through ch 3 at the optical input-side and output-side points on the east and west sides, and automatically set the cross-connects.

(Procedure 5) Providing Notification of Transmission Destination (Drop) Node Cross-Connect Setting

On final receipt of the squelch information indicating that “for channel 1, node A (ID=“01”) is the transmission source and node D (ID=“04”) is the transmission destination”, the node D determines that node D itself is the transmission destination (drop) node from the fact that the transmission destination node ID (DST) in the squelch information is “04” and an own node ID is also “04”. The node D further determines the concatenation type using a technique similar to the above-described technique and notifies the user with a message stating that “a setting request exists for a STS3C cross-connect from node A (ID=“01”) for channel 1”. As a result of the message, the user at node D is able to implement error-free cross-connect setting.

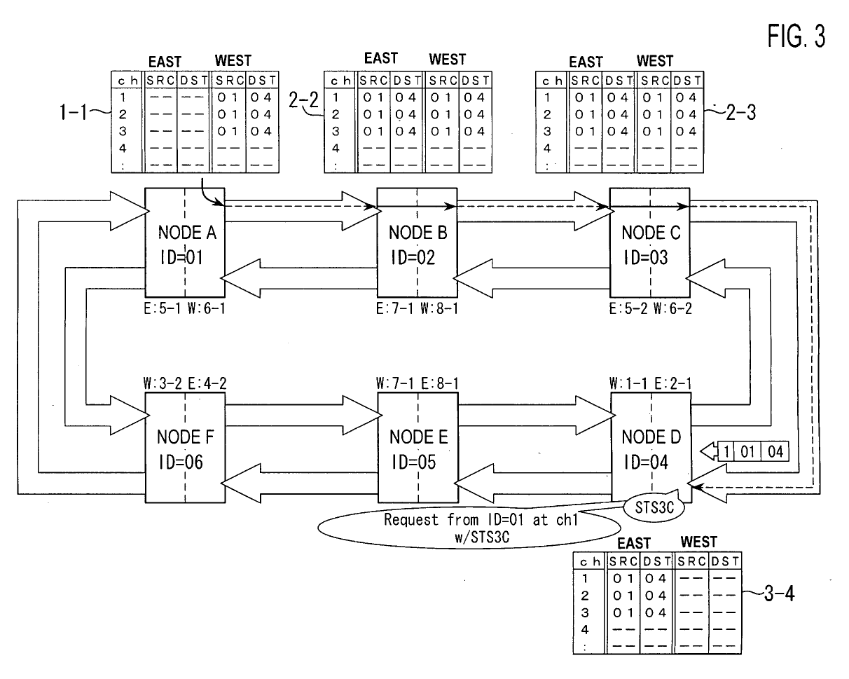

Hence, as shown in FIG. 3, the node D sets the cross-connect by setting the transmission source node ID (SRC) to “01” and the transmission destination node ID (DST) to “04” for channels ch 1 through ch 3 on the east side in the squelch table or by cross-connect command casting from the user.

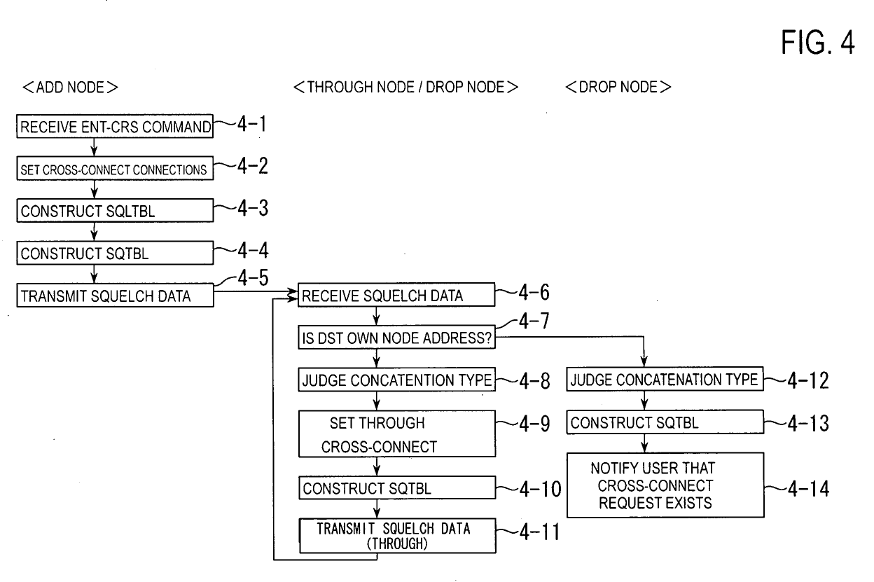

A flow of processing for the above described operation is shown in FIG. 4. As shown in FIG. 4, the add node receives the cross-connect setting command “ENT - CRS” (step 4-1), sets the cross-connect according to the command (step 4-2), and on receiving a squelch table editing command “ED - SQLTBL” resulting from manual setting (step 4-3), constructs a squelch table in accordance with the command (step 4-4) and transmits the squelch information to an adjacent node (step 4-5).

The through node receives the squelch information (step 4-6), judges whether the transmission destination node ID (DST) corresponds to an own node destination (step 4-7), and, when judging in the negative, determines a concatenation type (step 4-8), executes through cross-connect setting (step 4-9), constructs a squelch table (step 4-10), and (through) transmits the squelch information in an unaltered form to a succeeding node. The operations from step 4-6 are repeated in the same way exactly as many times as there are through nodes.

Since the drop node judges itself to be the destination node corresponding to the transmission destination node ID (DST) in the above-described step 4-7, the drop node subsequently determines a concatenation type (step 4-12), constructs a squelch table (step 4-13), and notifies the user with a message indicating the existence of the cross-connect request (step 4-14). The user then sends a command to set the cross-connect in the drop node based on the message.

According to the present invention described above, an optical bi-directional line-switched ring (BLSR) transmission system is capable of storing cross-connect setting information in a squelch information setting region of the optical overhead and notifying signal path nodes of the cross-connect setting information, thereby allowing through nodes on the signal path to automatically execute cross-connect setting based on the cross-connect setting information. Consequently, it is possible to automatically perform through cross-connect setting for the through nodes using software or firmware and without requiring any alteration to node hardware. Moreover, setting of the through cross-connects can be performed without a great deal of work and connection errors resulting from setting errors when setting the cross-connect can be prevented.

Also, since it is possible to notify each node of the cross-connect setting information using squelch data in an existing optical overhead in an unaltered conventional format, automatic setting of the cross-connects is possible in an optical bi-directional line-switched ring (BLSR) network that includes a transmission apparatus not equipped with the cross-connect setting functions according to the present invention. The only effect of such an arrangement is that the unequipped transmission device will be incapable of automatically setting the cross-connects. The other apparatuses will still be capable of automatically setting the cross connects without any impairment to existing functions.

Moreover, the apparatus can be allowed to operate in a mode in which squelch information is dealt with as input information for conventional squelch table construction or in a mode in which cross-connect setting information is dealt with in the manner described in the present invention. For instance, when setting up the apparatus, the apparatus can be operated in the mode which makes use of the cross-connect setting information of the present invention. Then, after a certain period, when the signal path has been formed as a result of the cross-connect setting, the conventional input information for squelch table construction mode can be used. This arrangement allows the use, in an unaltered form, of conventional functions, such as the sounding of an alarm when a squelch table mismatch occurs following the deletion of an erroneous disconnect and the like.

What is claimed is:

1. An optical bi-directional line-switched ring transmission system having a plurality of nodes connected in a ring-state, comprising:
a unit configured to transmit, from a transmission source node in a signal path for setting a cross-connect to an adjacent node, squelch information storing identity information of a transmission source node and a transmission destination node in a squelch information region provided in an optical overhead as an information region for construction of a squelch table;
in an own node that has received the squelch information, a unit configured to allocate cross-connect setting information based on the transmission source and transmission destination identity information and a concatenation type judged from setting information of the optical overhead, judge whether an own node is a transmission destination node or a through node of the cross-connect, and when judging that the own node is the through node, execute through cross-connect setting in the own node; and
a notifying unit configured to, when the own node has been judged to be the transmission destination node of the cross-connect, notify a user with a message indicating that a cross-connect setting request exists.

2. The optical bi-directional line-switched ring transmission system of claim 1, wherein
the information stored in the squelch information region is treated as information for cross-connect setting when setting of the cross-connect has not taken place and treated as information for constructing the squelch table when setting of the cross-connect has already taken place.

3. A transmission apparatus that is a node of an optical bi-directional switching transmission system, the transmission apparatus comprising:
a unit configured to transmit to an adjacent node squelch information storing transmission source node and transmission destination node identity information for setting cross-connect in a squelch information region provided in an optical overhead for constructing a squelch table;
a unit configured to allocate cross-connect setting information based on the transmission source node and transmission destination node identity information stored in the squelch information region and a concatenation type judged from the setting information of the optical overhead;
a unit configured to judge whether an own apparatus is a transmission destination node transmission apparatus or a through node transmission apparatus of the cross-connect based on the cross-connect setting information, and when judging that the own node transmission apparatus is the through node transmission apparatus, execute through cross-connect setting in the own apparatus based on the cross-connect setting information; and
a notifying unit configured to, when the own apparatus has been judged to be the transmission apparatus of the transmission destination node of the cross-connect, notify a user with a message indicating that a cross-connect setting request exists.

4. The transmission apparatus of claim 3, wherein
the information stored in the squelch information region is treated as information for cross-connect setting when setting of the cross-connect has not taken place and treated as information for constructing the squelch table when setting of the cross-connect has already taken place.

5. A through connect setting method of an optical bi-directional line-switched ring transmission system having a plurality of nodes connected in a ring-state, the through connect method comprising:
a step of transmitting, from a transmission source node in a signal path for setting a cross-connect to an adjacent node, squelch information storing transmission source node and transmission destination node identity information in a squelch information region provided in an optical overhead as an information region for construction of a squelch table;
a step of, in an own node that has received the squelch information configured, allocating cross-connect setting information based on the transmission source node and transmission destination node identity information and a concatenation type judged from setting information of the optical overhead, judging whether an own node is a transmission destination node or a through node of the cross-connect, and when judging that the own node is the through node, executing through cross-connect setting in the own node; and
a notifying step of, when the own node has been judged to be the transmission destination node of the cross-connect, notifying a user with a message indicating that a cross-connect setting request exists.
